(19) United States
(12) Patent Application Publication
(10) Pub. No.: US 2018/0202643 A1
(43) Pub. Date: Jul. 19, 2018

(54) MOUNTING PROFILE, SEPARABLE SIGNAGE MODULE CAPABLE OF EMITTING LIGHT, AND ILLUMINATION SYSTEM

(71) Applicant: OSRAM GmbH, Munich (DE)

(72) Inventors: Hua WANG, Shenzhen (CN); Jie TAN, Shenzhen (CN); Xiaoqing LI, Shenzhen (CN); ChengCheng FENG, Shenzhen (CN)

(21) Appl. No.: 15/872,024

(22) Filed: Jan. 16, 2018

(30) Foreign Application Priority Data
Jan. 16, 2017 (CN) 201710032370.7

(51) Int. Cl. F21V 23/06; F21V 17/16; G09F 13/00

(52) U.S. Cl. CPC F21V 23/06; G09F 13/00; F21V 17/16

(57) ABSTRACT

According to the present disclosure, a mounting profile includes at least one wire fixed thereto. The mounting profile is configured to be adapted to mount at least one separable signage module on the mounting profile, and in a mounting state, each of the at least one wire contacts a corresponding power supply terminal of each of the at least one separable signage module.

### CROSS-REFERENCE TO RELATED APPLICATION

This application claims priority to Chinese Patent Application Serial No. 201710032370.7, which was filed Jan. 16, 2017, and is incorporated herein by reference in its entirety.

### TECHNICAL FIELD

The disclosure relates generally to an illumination system, and particularly to a mounting profile, a separable signage module capable of emitting light, and an illumination system comprising a mounting profile and a separable signage module.

### BACKGROUND ART

Recently, many signage products have been used for assembling a lamp box and a channel letter. As shown in FIG. 1, an illumination system 10 usable in a lamp box and a channel letter comprises a mounting profile 13 and a plurality of separable signage modules 11 capable of emitting light, wherein in a mounting state, the separable signage modules 11 are fixed on the mounting profile 13, and in the mounting state, a non-fixed wire 15 exists between two adjacent separable signage modules 11. Both ends of the non-fixed wire 15 are fixed, while the intermediate part thereof is movable. For example, when a length of the non-fixed wire 15 between two adjacent separable signage modules 11 is greater than a distance between power supply terminals of the two adjacent separable signage modules, the non-fixed wire 15 may be enlaced and fixed on the mounting profile 13. The non-fixed wire 15 is used for connecting the respective separable signage modules and supplying power for the respective separable signage modules.

### SUMMARY OF THE INVENTION

A brief summary of the disclosure is given below to provide a basic understanding to some aspects of the disclosure. It should be understood that the summary is not exhaustive. It does not intend to define a key or important part of the disclosure, nor does it intend to limit the scope of the disclosure. The object of the summary is only to present some concepts, in a simplified manner, as a preamble of the more detailed description that follows.

In the art, an illumination system is desired to have: easier design, lower assembling cost, convenient production line arrangement, and easier installation.

In view of the foregoing desires, the inventor designs the technical solution below.

According to one aspect of the disclosure, there is provided a mounting profile, on which at least one wire is fixed; wherein the mounting profile is configured to: be adapted to mount at least one separable signage module on the mounting profile, and in a mounting state, each of the at least one wire contacts a corresponding power supply terminal of each of the at least one separable signage module.

According to another aspect of the disclosure, there is provided an illumination system, comprising: at least one separable signage module capable of emitting light; and the aforementioned mounting profile.

According to yet another aspect of the disclosure, there is provided a separable signage module capable of emitting light, comprising: a power supply terminal; wherein the separable signage module is configured to: have a shape adapted to be mounted on a mounting profile, at least one wire is fixed on the mounting profile, and in a mounting state, the at least one wire contacts corresponding power supply terminals of the at least one separable signage module.

The technical solution according to the disclosure has at least one of the following advantageous technical effects: easier design, lower assembling cost, convenient production line arrangement, and easier installation.

### BRIEF DESCRIPTION OF THE DRAWINGS

The disclosure could be better understood with reference to the descriptions made in combination with the appended drawings hereinafter. It should be appreciated that the appended Drawings is not necessarily scaled. In the appended Drawings:

FIG. 1 is a schematic view of a conventional illumination system;

FIG. 2 is a schematic view of an illumination system according to an embodiment of the disclosure;

FIG. 3 is a perspective view of a mounting profile in FIG. 2;

FIG. 4 is a schematic view of an illumination system according to an embodiment of the disclosure;

FIG. 5 is a schematic view of an illumination system according to an embodiment of the disclosure;

FIG. 6 is a schematic view of an illumination system according to an embodiment of the disclosure;

FIG. 7 is a schematic view of an illumination system according to an embodiment of the disclosure;

FIG. 8 is a schematic view of an illumination system according to an embodiment of the disclosure;

FIG. 9 is a schematic view of an illumination system according to an embodiment of the disclosure; and

FIG. 10 is a schematic view of an illumination system according to an embodiment of the disclosure.

### DETAILED DESCRIPTION OF THE EMBODIMENTS

Exemplary embodiments of the disclosure will be described in combination with the appended drawings below. For the sake of clarity and conciseness, the specification does not describe all features of actual embodiments. However, it should be understood that in developing any such an actual embodiment, many decisions specific to the embodiment may be made, so as to achieve specific objects of a developer, and these decisions possibly vary as embodiments are different.

It should also be noted that, to avoid the disclosure from being obscured due to unnecessary details, only those device structures closely related to the solutions according to the disclosure are shown in the appended drawings, while other details not closely related to the disclosure are omitted.

Various embodiments of the illumination system according to the disclosure will be described below.

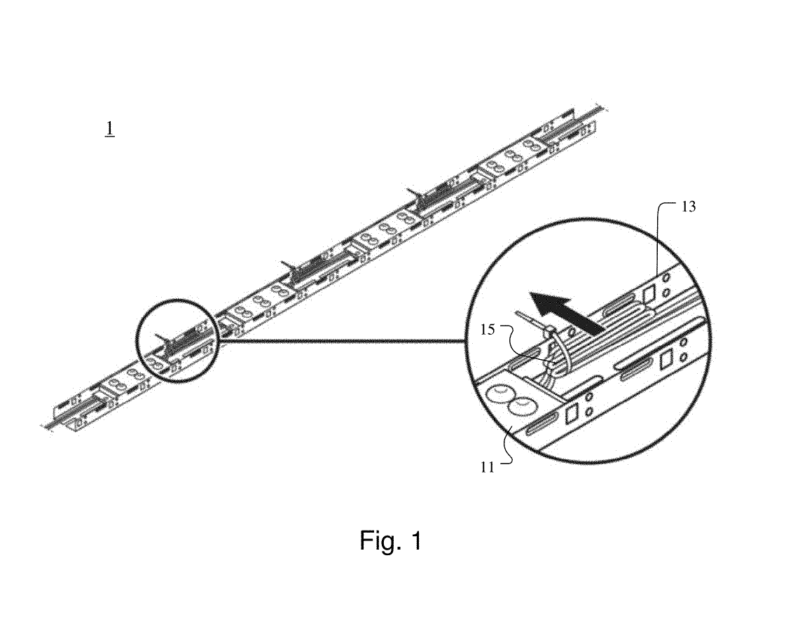

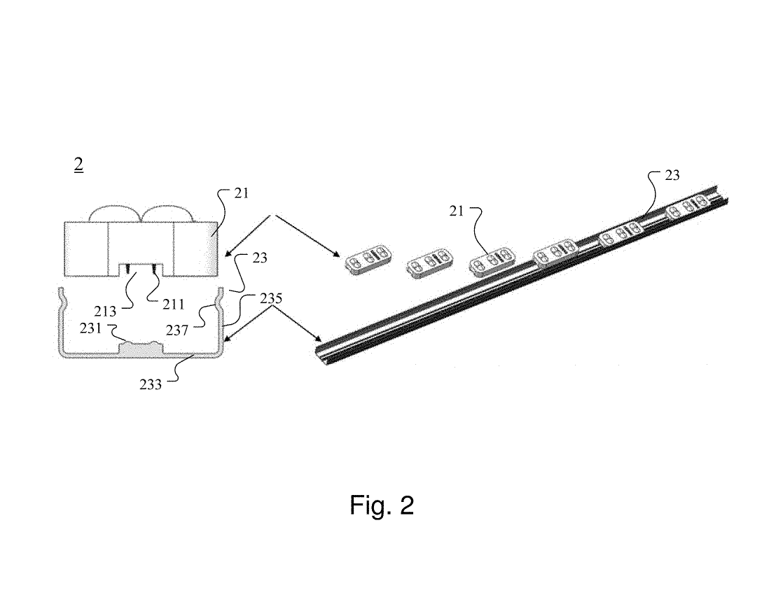

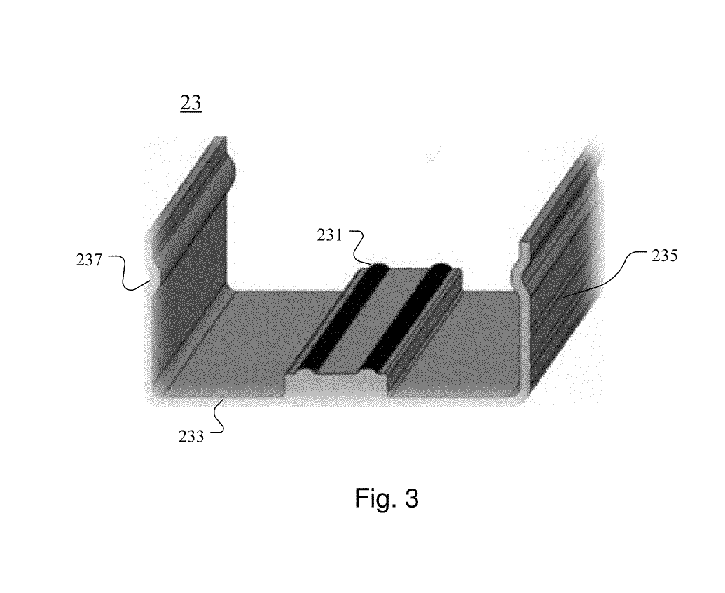

FIG. 2 is a schematic view of an illumination system 2 according to an embodiment of the disclosure. FIG. 3 is a perspective view of a mounting profile 23 in FIG. 2. The illumination system 2 comprises a separable signage module 21 and a mounting profile 23. The separable signage module 21 is capable of emitting light. The separable signage module 21 has a light emitting unit such as an LED chip. The number of the separable signage module 21 is at least one. The separable signage module 21 has a power supply terminal 211. The number of the power supply terminal may be selected according to requirements. At least one wire 231 is fixed on the mounting profile 23. As an example, FIG. 3 shows two wires. The mounting profile 23 is configured to: be adapted to mount at least one separable signage module 21 on the mounting profile 23, and in a mounting state, each of the at least one wire contacts a corresponding power supply terminal of each of the at least one separable signage module 21. In a case where the wire 231 supplies power, the separable signage module 21 in a contact state emits light. A contact manner between the power supply terminal 211 and the wire 231 may be point contact or surface contact, and preferably surface contact. A connection manner between the power supply terminal 211 and the wiring 231 may be insertion. Differently from the mounting profile 13 in FIG. 1, the mounting profile 23 is integrated with a fixed wire, so it is not necessary to provide a conventional non-fixed wire between the two adjacent separate signage modules as mounted, that is, electrical connection can be implemented by assembling the separable signage module 21 and the mounting profile together, without needing any wire other than the detachable signage module and the mounting profile.

For the illumination system 10 in FIG. 1, a spacing between two adjacent separable signage modules is limited by a length of a non-fixed wire therebetween, and a long non-fixed wire will increase cost and reduce assembling convenience.

For the illumination system 2, since no non-fixed wire between two adjacent separable signage modules is used, a spacing between adjacent separable signage modules may be easily and conveniently adjusted, and the illumination system 2 may have lower cost. Designing and producing the mounting profile 23 and the separable signage module 21 are also easily implemented, and meanwhile such an illumination system structure is also advantageous to simplification of production line arrangement.

As shown in FIG. 2, as an example, there is a groove 213 at the bottom of the separable signage module 21. The groove 213 is adapted to be inserted into a protrusion of the mounting profile 23 which extends in a lengthwise direction of the mounting profile. To ensure reliable electrical contact, the power supply terminal 211 preferably has elasticity. In FIG. 2, the power supply terminal 211 is needle-like. The wire 231 of the mounting profile for example has a hole for insertion of the corresponding power supply terminal of each separable signage module (not shown in FIGS. 2 and 3). A plurality of holes may be arranged at a predetermined smaller spacing on the wire, such that a distance between adjacent separable signage modules may be finely adjusted. Spacings between adjacent holes on the same wire may be different.

As shown in FIG. 3, the groove-shaped mounting profile 23 has a bottom surface 233 and lateral surfaces 235. A convex 237 for fixing the separable signage module by buckling exists on the lateral surface 235.

Alternatively, the wire of the mounting profile may be formed as a convex edge covered with a conductive material. Covering technology may be selected from: electroplating, sputtering, spraying, printing, chemical plating, distilling and the like. The wire 231 as shown in FIG. 3 is exemplarily formed as a convex edge on a bump on the bottom surface of the mounting profile, wherein a surface of the convex edge is covered with a conductive material. The convex edge may also be entirely formed by a conductive material.

In the disclosure, the wire of the mounting profile and the power supply terminal of the separable signage module have shapes which match each other, so as to ensure reliable electrical contact between the wire of the mounting profile and the power supply terminal of the separable signage module. In the disclosure, the wire of the mounting profile and the separable signage module have shapes which match each other, so as to allow the separable signage module to be fixed on the mounting profile. In the disclosure, the shapes and arrangements of the separable signage module, the power supply terminal, the mounting profile and the wire are not limited to the shapes and arrangements as shown in FIGS. 2 and 3.

In the disclosure, the mounting profile may be configured to fix the respective separable signage modules by an elastic force in a mounting state. For the illumination system 2 in FIGS. 2 and 3, the mounting profile 23 is a groove-shaped profile, the lateral surface 235 has elasticity, and each lateral surface has a convex 237. In the mounting state, the convex may buckle the separable signage module 21, so as to ensure the wire to contact the power supply terminal of the separable signage module and/or fix the separable signage module 21. Other manners such as bonding may also be adopted to fix the separable signage module on the mounting profile.

The illumination system 2 may be easily assembled. When assembling the illumination system 2, firstly, the separable signage module 21 may be placed on the mounting profile 23, wherein at least one wire is aligned with the corresponding power supply terminal of the separable signage module; then, the separable signage module 21 is pressed, such that at least one contacts the corresponding power supply terminal of the separable signage module 21, the convex 237 buckles a top surface of the separable signage module 21.

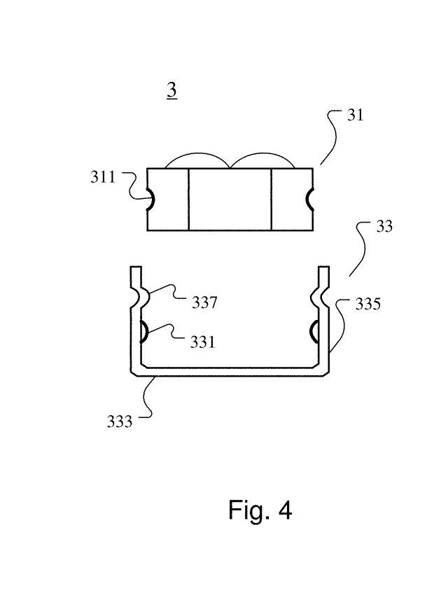

Although in FIG. 3 the wire 231 is exemplarily formed on the bottom surface 233, in the disclosure the wires may also be formed on lateral surfaces of the mounting profile. For example, the wires may be respectively formed on two opposite lateral surfaces of the groove-shaped profile. FIG. 4 is a schematic view of an illumination system 3 according to an embodiment of the disclosure. The illumination system 3 comprises a separable signage module 31 and a mounting profile 33. Power supply terminals 311 are provided on lateral surfaces of the separable signage module 31. The mounting profile 33 comprises a bottom surface 333 and lateral surfaces 335. A wire 331 and a convex 337 are provided on the lateral surface 335. In a mounting state, the power supply terminal 311 contacts the wire 331, and a top surface of the separable signage module 31 contacts the convex 337. Although in FIG. 4 the power supply terminal 311 is shown as being recessed inwardly and the wire 337 is shown as being protruded outwardly, the wire 331 and the power supply terminal 311 may also have other shapes capable of realizing contact with each other in the mounting state; for example, the wire is recessed inwardly, and the power supply terminal is protruded outwardly. In addition, the manner of fixing the separable signage module is not limited to using the convex 337.

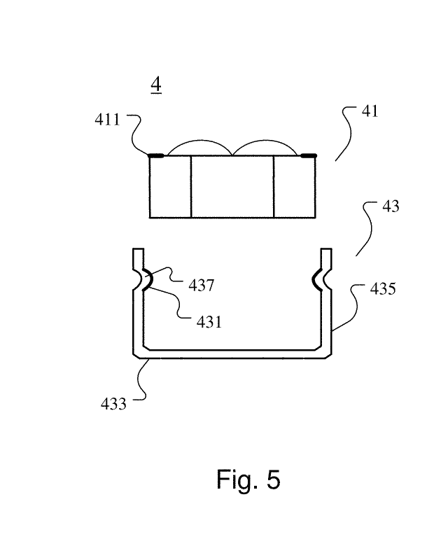

Alternatively, in the disclosure the wires may also be formed on convexes on lateral sides of the mounting profile. FIG. 5 is a schematic view of an illumination system 4 according to an embodiment of the disclosure. The illumination system 4 comprises a separable signage module 41 and a mounting profile 43. Power supply terminals 411 are provided on a top surface of the separable signage module 41. The mounting profile 43 comprises a bottom surface 433 and lateral surfaces 435. A wire 431 and a convex 437 are provided on the lateral surface 435. The wire 431 may be formed for example by covering a conductive material at a lower part of the convex 437. The wire 431 may also be formed for example by covering a conductive material on the entire convex 437. In a mounting state, the power supply terminal 411 contacts the wire 431, and the top surface of the separable signage module 41 contacts the convex 437.

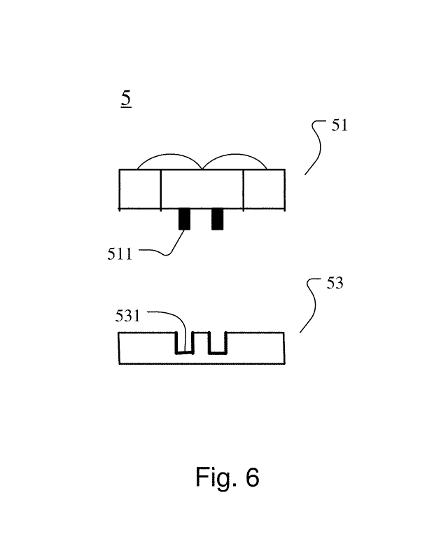

Although in FIGS. 2 and 3 the mounting profile 23 is shown as being a groove-shaped profile, in the disclosure the mounting profile may also have other shapes, for example a tablet shape. FIG. 6 is a schematic view of an illumination system 5 according to an embodiment of the disclosure. The illumination system 5 comprises a separable signage module 51 and a mounting profile 53. Power supply terminals 511 are provided on a bottom surface of the separable signage module 51. The mounting profile 53 comprises a wire 531 having a shape that matches with the power supply terminal 511. The wire 531 may be formed for example by at least partially covering a conductive material on a surface of a groove of the mounting profile. In a mounting state, the power supply terminal 511 is inserted into the groove to contact the wire 531. Such insertion performs the function of electrical contact, and also performs the function of fixing the separable signage module 51. The shapes of the power supply terminal 511 and the wire 531 are not limited to the rectangle as shown in the FIGS. 2 and 3, but may also be other shapes such as a wedge.

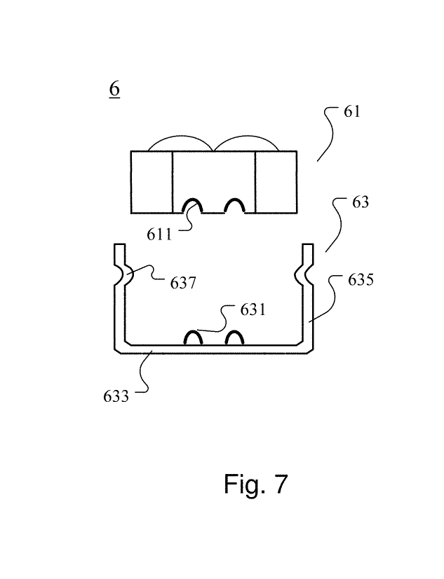

In the disclosure, alternatively, the wire of the mounting profile may be formed in such a manner that the mounting profile has a convex edge extending along a lengthwise direction of the mounting profile, wherein the convex edge directly protrudes from a bottom surface of the mounting profile. In this case, the corresponding power supply terminal of the separable signage module may be designed to have a shape that matches with the convex edge, such that in a mounting state the power supply terminal contacts the wire. FIG. 7 is a schematic view of an illumination system 6 according to an embodiment of the disclosure. The illumination system 6 comprises a separable signage module 61 and a mounting profile 63. Power supply terminals 611 are provided on a bottom surface of the separable signage module 61. The mounting profile 63 comprises a bottom surface 633 and lateral sides 635. A convex 637 is provided on the lateral side 635. A wire 631 is provided on the bottom surface 633. The wire 631 is formed in such a manner that the mounting profile 63 has a convex edge extending along a lengthwise direction of the mounting profile. A surface of the convex edge is covered with a conductive material, or the convex edge is entirely formed by a conductive material. The power supply terminal of the separable signage module may be designed to have a shape that matches the convex edge. For example, the power supply terminal 611 in FIG. 7 is recessed inwardly, and the surface recessed inwardly is covered with a conductive material. In a mounting state, the power supply terminal 611 contacts the wire 631.

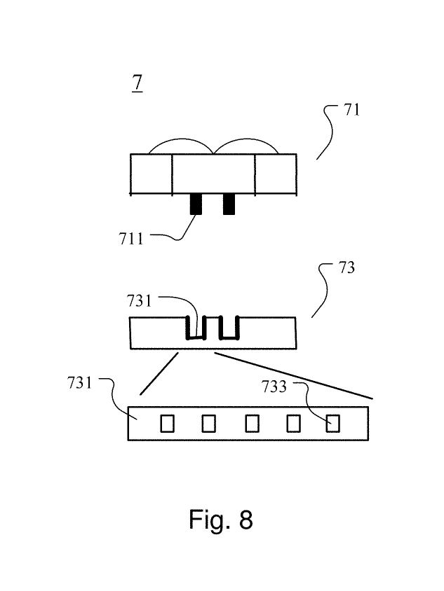

In the disclosure, alternatively, the wire of the mounting profile may be a lead inlaid in a groove on an inner surface of the mounting profile. The lead may have a circular section or a rectangular section. FIG. 8 is a schematic view of an illumination system 7 according to an embodiment of the disclosure. The illumination system 7 comprises a separable signage module 71 and a mounting profile 73. Power supply terminals 711 are provided on a bottom surface of the separable signage module 71. The mounting profile 73 comprises a wire 731 having a shape that matches with the power supply terminal 711. The wire 731 is a lead inlaid in a groove on an inner surface of the mounting profile. There is a hole 733 on the lead to accommodate the power supply terminal 711. The schematic view of the lowermost wire 731 in FIG. 8 is a top view of the wire 731 along a lengthwise direction of the wire 731. In the top view, it can be seen that a plurality of holes 733 are distributed in the wire 731. In a mounting state, the power supply terminal 711 is inserted into the hole 733 to contact the wire 731.

In the disclosure, a plurality of wires are not limited to be all formed on a bottom surface of the mounting profile, a plurality of wires are also not limited to be all formed on lateral surfaces of the mounting profile, and a plurality of wires are also not limited to be all formed on two lateral surfaces of the mounting profile.

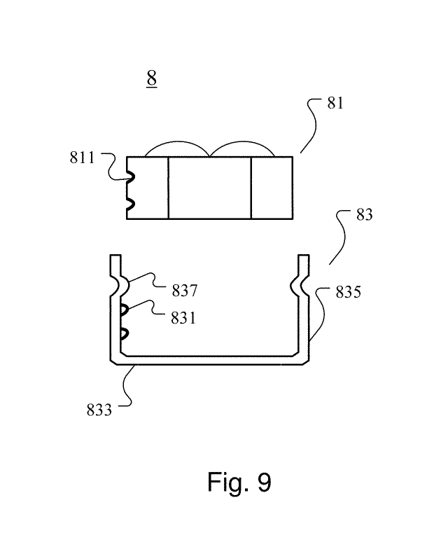

FIG. 9 is a schematic view of an illumination system 8 according to an embodiment of the disclosure. The illumination system 8 comprises a separable signage module 81 and a mounting profile 83. Instead of providing power supply terminals on both sides of the separable signage module 81, all power supply terminals 811 of the separable signage module 81 are provided at one side of the separable signage module 81. The mounting profile 83 comprises a bottom surface 833 and laterals surface 835. A wire 831 is provided only on one lateral surface of the mounting profile 83. Both of the laterals surfaces are provided with convexes 837. In a mounting state, the power supply terminal 811 contacts the wire 831, and a top surface of the separable signage module 81 contacts the convex 837. Although in FIG. 9 the power supply terminal 811 is shown as being recessed inwardly and the wire 831 is shown as being protruded outwardly, the wire 831 and the power supply terminal 811 may also have other shapes capable of realizing contact with each other in the mounting state; for example, the wire is recessed inwardly, and the power supply terminal is protruded outwardly. In addition, the manner of fixing the separable signage module is not limited to using the convex 837.

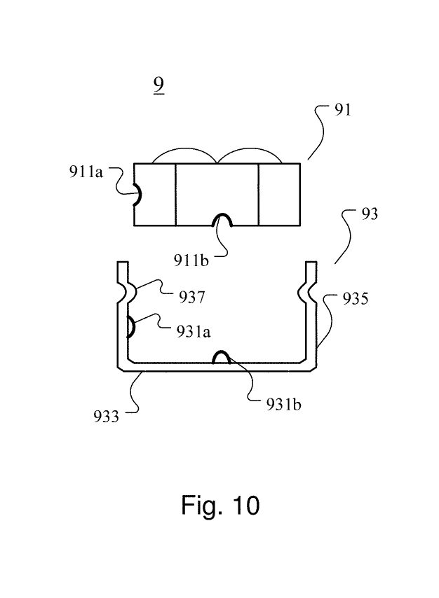

FIG. 10 is a schematic view of an illumination system 9 according to an embodiment of the disclosure. The illumination system 9 comprises a separable signage module 91 and a mounting profile 93. The separable signage module 91 comprises power supply terminals 911a provided on lateral surfaces of the separable signage module 81 and power supply terminals 911b provided on a bottom surface of the separable signage module 81 (the power supply terminals 911a and 911b may be collectively referred as power supply terminals 911). The mounting profile 93 comprises a bottom surface 933 and lateral surfaces 935. The mounting profile 93 comprises a wire 931a provided on the lateral surface 935 and a wire 931b provided on the bottom surface 933 (the wires 931a and 931b may be collectively referred as wires 931). Convexes 937 are provided on both lateral surfaces of the mounting profile 93. In a mounting state, the power supply terminal 911a contacts the wire 931a, the power supply terminal 911b contacts the wire 931b, and a top surface of the separable signage module 91 contacts the convex 937. Although in FIG. 10 the power supply terminal is shown being recessed inwardly and the wire is shown as being protruded outwardly, the wire and the power supply terminal may also have other shapes capable of realizing contact with each other in the mounting state; for example, the wire is recessed inwardly, and the power supply terminal is protruded outwardly. In addition, the shapes of the plurality of power supply terminals on the same separable signage module 91 may be different (for example, a power supply terminal inwardly recessed and a power supply terminal protruded outwardly exist simultaneously), and the shapes of the plurality of wires on the mounting profile 93 may also be different (for example, a wire protruded outwardly and a wire inwardly recessed exist simultaneously).

The illumination systems according to the disclosure are adapted to a lamp box or a channel letter.

In the disclosure, the mounting profile is integrated with a fixed wire, without requiring arrangement of a non-fixed wire between two adjacent separable signage modules. Thus, the technical solution of the disclosure is advantageous to produce at least one of the following advantageous technical effects: easier design, lower assembling cost, convenient production line arrangement, and easier installation.

It should be understood that the different embodiments or features described herein may be combined, where feasible, unless otherwise indicated.

Although the disclosure has been disclosed above by describing the detailed embodiments of the disclosure, it should be understood that those skilled in the art could carry out various modifications, improvements or equivalents for the disclosure within the spirit and scope of the appended claims. Such modifications, improvements or equivalents should also be regarded as being included within the scope of protection of the disclosure.

It should be emphasized that when being used herein, terms “include/comprise” indicate existence of features, elements or assemblies, without excluding existence or addition of one or more other features, elements or assemblies.

### LIST OF REFERENCE SIGNS

Illumination system 1
Signage modules 11
Mounting profile 13
Non-fixed wire 15
Illumination system 2
Separable signage module 21
Mounting profile 23
Power supply terminal 211
Groove 213
Wire 231
Bottom surface 233
Lateral surface 235
Convex 237
Illumination system 3
Separable signage module 31
Mounting profile 33
Power supply terminal 311
Wire 331
Bottom surface 333
Lateral surface 335
Convex 337
Illumination system 4
Separable signage module 41
Mounting profile 43
Power supply terminal 411
Wire 431
Bottom surface 433
Lateral surface 435
Convex 437
Illumination system 5
Separable signage module 51
Mounting profile 53
Power supply terminal 511
Wire 531
Illumination system 6
Separable signage module 61
Mounting profile 63
Power supply terminal 611
Wire 631
Bottom surface 633
Lateral surface 635
Convex 637
Illumination system 7
Separable signage module 71
Mounting profile 73
Power supply terminal 711
Wire 731
Hole 733
Illumination system 8
Separable signage module 81
Mounting profile 83
Power supply terminal 811
Wire 831
Bottom surface 833
Lateral surface 835
Convex 837
Illumination system 9
Separable signage module 91
Mounting profile 93
Power supply terminal 911
Power supply terminal 911a
Power supply terminal 911b
Bottom surface 933
Lateral surface 935
Wire 931
Wire 931a
Wire 931b
Convex 937

1. A mounting profile comprising at least one wire fixed thereto,
wherein the mounting profile is configured to be adapted to mount at least one separable signage module on the mounting profile, and in a mounting state, each of the at least one wire contacts a corresponding power supply terminal of each of the at least one separable signage module.

2. The mounting profile according to claim 1, wherein the mounting profile is a groove-shaped profile.

3. The mounting profile according to claim 1, wherein each of the at least one wire is formed in such a manner that the mounting profile has a protrusion extending along a lengthwise direction of the mounting profile.

4. The mounting profile according to claim 1, wherein each of the at least one wire is formed as a convex edge covered with a conductive material.

5. The mounting profile according to claim 1, wherein each of the at least one wire is a convex edge covered with a conductive material which extends in a lengthwise direction of the mounting profile, and the convex edge directly protrudes from a bottom surface of the mounting profile.

6. The mounting profile according to claim 2, wherein the at least one wire is formed on lateral surfaces of the groove-shaped profile.

7. The mounting profile according to claim 2, wherein the at least one wire includes wires which are respectively formed on two opposite lateral surfaces of the groove-shaped profile.

8. The mounting profile according to claim 1, wherein the at least one wire is a lead inlaid in a groove on an inner surface of the mounting profile.

9. The mounting profile according to claim 8, wherein the lead has a circular section or a rectangular section.

10. The mounting profile according to claim 1, wherein the at least one wire has a hole for insertion of the corresponding power supply terminal of each of the at least one separable signage module.

11. The mounting profile according to claim 1, wherein the mounting profile is configured to fix the at least one separable signage module by an elastic force in the mounting state.

12. An illumination system, comprising:
at least one separable signage module capable of emitting light; and
a mounting profile on which at least one wire is fixed, wherein the mounting profile is configured to be adapted to mount at least one separable signage module on the mounting profile, and in a mounting state, each of the at least one wire contacts a corresponding power supply terminal of each of the at least one separable signage module.

13. A separable signage module capable of emitting light, comprising:
a power supply terminal;
wherein the separable signage module is configured to: have a shape adapted to be mounted on a mounting profile wherein at least one wire is fixed on the mounting profile, and in a mounting state, the at least one wire contacts corresponding power supply terminals of the at least one separable signage module.

14. The separable signage module according to claim 13, wherein the power supply terminal is adapted to be inserted into a hole of the at least one wire.

15. The separable signage module according to claim 13, further comprising: a groove, the power supply terminal being provided in the groove, and the groove being adapted to be inserted into a protrusion of the mounting profile which extends along a lengthwise direction of the mounting profile.
